(19) United States
(12) Patent Application Publication
(10) Pub. No.: US 2006/0247918 A1
(43) Pub. Date: Nov. 2, 2006

(54) Systems and methods for 3D audio programming and processing

(75) Inventors: Brian L. Schmidt, Bellevue, WA (US); Scott P. Selfon, Redmond, WA (US); Dugan O. Porter, Seattle, WA (US); Duncan J. McKay, Redmond, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/118,747

(22) Filed: Apr. 29, 2005

(51) Int. Cl. G10L 11/00

(52) U.S. Cl. 704/200

(57) ABSTRACT

Systems and methods for 3D audio programming and processing are provided wherein digital signal processing (DSP) settings are calculated for 3D audio effects for a digital audio signal independently of DSP rendering of the digital audio signal. Coordinates of locations within a 3D environment representing at least one sound source and at least one audio listener are created and passed (along with other distance modeling parameters) to a DSP settings generator having 3D audio library routines to calculate the DSP settings for 3D audio effects based on the distances between the at least one sound source and at least one audio listener and the distance modeling parameters. Support for positional multi-channel sounds and non point-source emitters is also present.

### FIELD OF THE INVENTION

This invention generally relates to the field of digital audio signal processing. In particular, the invention is directed to digital audio signal programming and processing in the simulation of sounds moving through three dimensional (3D) space within a multimedia application.

### BACKGROUND OF THE INVENTION

3D positional audio in multimedia applications uses signal processing to localize a single sound to a specific location in three dimensional space around the listener. 3D positional audio is the most common sound effect used in multimedia applications such as interactive games because a sound effect, such as the sound of an opponent's automobile, can be localized to a specific position. This position, for instance, could be behind the listener and quickly moving around the left side while all the other sounds are positioned separately.

One of the reasons that 3D positional audio is so popular in action video games is because it can be interactive. Sounds don't have to be preprocessed during the game's development to position the sound. As the listener changes location in a virtual world, all the sound objects can maintain their correct location speed and path of motion around the listener as the action unfolds.

3D positional audio generally refers to a system where multimedia applications can use application programming interfaces (API's) to set the position of sounds in 3D space. “Head-Related Transfer Function” (HRTF) is one mechanism for achieving that. HRTF is a method by which sounds are processed to localize them in space around the player or user. Although this technique is acceptable for 3D positioning, it requires a large amount of processing power. This is the reason 3D audio hardware accelerators are becoming so common in personal computers (PCs). Another might be surrounding the user with speakers, etc.

Developers of multimedia applications such as interactive video games that have 3D audio generally use an 3D audio application programming interface (API) that interfaces with lower level 3D audio rendering routines and/or the audio hardware accelerator to include 3D audio capability. An API is series of software routines and development tools that comprise an interface between a computer application and lower-level services and functions (e.g. the operating system, device drivers, and other low-level software). APIs serve as building blocks for programmers putting together software applications. For example, in the case of interactive multimedia applications having 3D audio, developers may use 3D audio APIs such as Microsoft® DirectSound3D® API, Environmental Audio Extensions (EAX®), and Aureal® 3D (A3D®). These, in turn may have lower level audio rendering APIs.

However, in many common 3D audio APIs, the hardware resources, raw audio data, and 3D audio positional parameters are all encapsulated in a single monolithic 3D buffer object. Also, the 3D audio sound-source object within a 3D audio API may tie 3D positional parameters to a given audio voice. By coupling 3D parameters to rendering resources, these designs inherently tie 3D audio positional algorithms to the underlying rendering API, restricting a multimedia application developer's ability to modify such functionality to suit their needs.

Thus, there is a need for systems and methods for 3D audio programming and processing that does not tie 3D audio positional algorithms to the underlying audio rendering API, and provides more transparency and flexibility to application developers by allowing them to alter the way geometry calculations behave independent of low level digital signal processing (DSP) implementation.

### SUMMARY OF THE INVENTION

The invention is directed to systems and methods for 3D audio programming and processing. In particular, a method is described for three dimensional (3D) audio processing comprising calculating digital signal processing (DSP) settings for 3D audio effects for a digital audio signal independently of DSP rendering of the digital audio signal. Also, the act of calculating DSP settings may comprise receiving coordinates of locations within a 3D environment representing at least one sound source and at least one audio listener and calculating the DSP settings for 3D audio effects based on the distances between at least one sound source and at least one audio listener. This method may further comprise receiving at least one parameter relating to audio behavior from the at least one sound source in relation to the at least one listener within the 3D environment and calculating the DSP settings for 3D audio effects based on the at least one parameter received and the distances between the at least one sound source and at least one audio listener. The DSP settings may then be communicated to a multimedia application engine or an audio rendering application programming interface (API).

Additional features of the invention will be made apparent from the following detailed description of illustrative embodiments that proceeds with reference to the accompanying drawings.

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings illustrative embodiments of the invention; however, the invention is not limited to the specific methods and instrumentalities disclosed. In the drawings:

FIG. 1 is an illustration of various locations of exemplary virtual emitters of audio in a three dimensional (3D) coordinate system, in accordance with an aspect of the invention.

FIG. 2 is an illustration of various locations of exemplary virtual listeners representing points of audio reception in a 3D coordinate system, in accordance with an aspect of the invention.

FIG. 3 is an illustration of the various locations of both the virtual emitters and virtual listeners of FIGS. 1 and 2 together in a single 3D coordinate system, in accordance with an aspect of the invention.

FIG. 4 is a block diagram of the architecture of a system for 3D audio processing, in accordance with an aspect of the invention.

FIG. 5 is a block diagram of the architecture of a system for 3D audio processing, in accordance with an aspect of an alternative embodiment of the invention.

FIG. 6 is a flowchart illustrating a method for 3D audio processing, in accordance with an aspect of the invention.

FIG. 7 is a graph of an exemplary filter coefficient curve according to distance between emitters and listeners of FIG. 3 used in determining digital signal processing (DSP) settings, in accordance with an example of curves used in an aspect of the invention.

FIG. 8 is a graph of an exemplary reverberation (reverb) level curve according to distance between emitters and listeners of FIG. 3 used in determining DSP settings, in accordance with an example of curves used in an aspect of the invention.

FIG. 9 is a graph of an exemplary volume level curve according to distance between emitters and listeners of FIG. 3 used in determining DSP settings, in accordance with an example of curves used in an aspect of the invention.

FIG. 10 is a graph of an exemplary low frequency effects (LFE) level curve according to distance between emitters and listeners of FIG. 3 used in determining DSP settings, in accordance with an example of curves used in an aspect of the invention.

FIG. 11 is an illustration showing the setting of the azimuth of monophonic (mono), or single channel, sound in accordance with an aspect of the invention.

FIG. 12 is an illustration showing the setting of the azimuth of an exemplary multi-channel sound having three channels, in accordance with an aspect of the invention.

FIG. 13 is a block diagram showing an exemplary multimedia console, in which many computerized processes, including those of various aspects of the invention, may be implemented;

FIG. 14 is a block diagram showing further details of the exemplary multimedia console of FIG. 13, in which many computerized processes, including those of various aspects of the invention, may be implemented;

FIG. 15 is a block diagram representing an exemplary computing device in which many computerized processes, including those of various aspects of the invention, may be implemented; and

FIG. 16 illustrates an exemplary networked computing environment in which many computerized processes, including those of various aspects of the invention, may be implemented.

### DETAILED DESCRIPTION OF ILLUSTRATIVE EMBODIMENTS

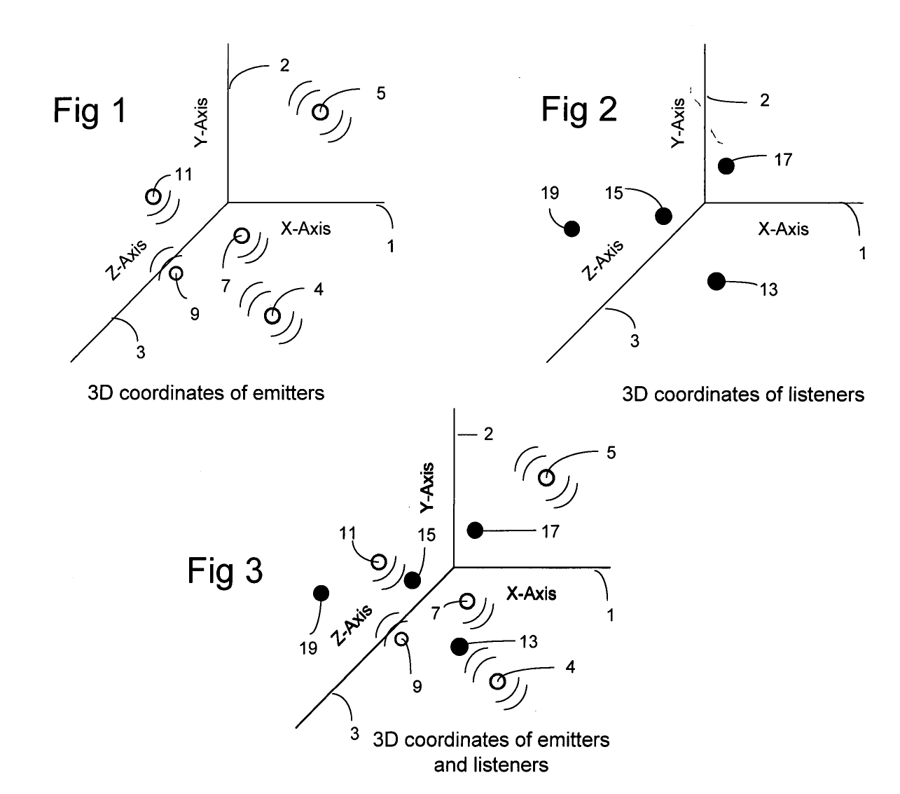

Referring first to FIG. 1, shown is an illustration of various locations of exemplary virtual emitters of audio in a three dimensional (3D) coordinate system, in accordance with an aspect of the invention. 3D audio allows for on-the-fly positioning of sounds anywhere in the three-dimensional space surrounding a listener represented by a three dimensional Cartesian coordinate system having an x-axis 1, y-axis 2 and z axis 3 for each dimension. This 3D system often corresponds to the graphical data being displayed by the multimedia application, such as a video game, for example. Support for such technologies can be incorporated into software titles such as video games to create a natural, immersive, and interactive audio environment that closely approximates a real-life listening experience.

Due to the interactive aspect of many multimedia applications such as computers games, it is desirable to be able to render multiple sounds within a scene, often dozens or more at a time. Though it is unlikely that the listener will be able to hear and locate any more sounds than that at one time, which ones will be required at any instant is probably impossible to predict in any well-written interactive multimedia application. Therefore, the system must be rendering multiple sounds at all times, even if they are currently playing at lower volumes than other sounds and therefore momentarily inaudible. The more sources that can be rendered at once, the better an interactive audio rendering engine can perform the illusion of a realistic sound environment, and the more layers of sound, the closer it approaches realism. Accordingly, each point on the 3D coordinate system of FIG. 1 represents a sound source (emitter) 4, 5, 7, 9, 11 at a different location within the 3D environment. A sound source is an object to be rendered in the virtual world of a multimedia application that emits sound waves. Examples are anything that makes sound—cars, humans, gunfire, animals, closing doors, etc. Sound waves get generated through a variety of mechanical processes. Once created, the waves usually get radiated in a certain direction, such as shown with emitters 7, 9 and 11. For example, a mouth radiates more sound energy in the direction the face is pointing that to the side of the face. Also, sounds can be multi-directional or omni-directional such as shown with emitters 4 and 5.

Referring next to FIG. 2, shown is an illustration of various locations of exemplary virtual listeners 13, 15, 17, 19 representing points of audio reception in a 3D coordinate system, in accordance with an aspect of the invention. The audio environment is viewed from the perspective of the listener(s) 13, 15, 17, 19 and often corresponds to the view being depicted on a computer screen, for example, to the user.

Referring next to FIG. 3, shown is an illustration of the various locations of both the virtual emitters 4, 5, 7, 9, 11 and virtual listeners 13, 15, 17, 19 of FIGS. 1 and 2 together in a single 3D coordinate system, in accordance with an aspect of the invention. If the listener or listeners are stationary, then the movement of the emitters 4, 5, 7, 9, 11 provide key information to be tracked. If both the listener(s) 13, 15, 17, 19 and the emitters 4, 5, 7, 9, 11 are moving, then the relative distance from each listener 13, 15, 17, 19 to each emitter 4, 5, 7, 9, 11 is calculated. Also, the location of the user's head and their head's orientation are key to locating the ears and may be needed for proper rendering of the audio content. The current positions of the both the listener(s) 13, 15, 17, 19 and the emitters 4, 5, 7, 9, 11 are recorded using the 3D coordinate system 1, 2, 3 which may correspond to the graphical data being displayed by the multimedia application.

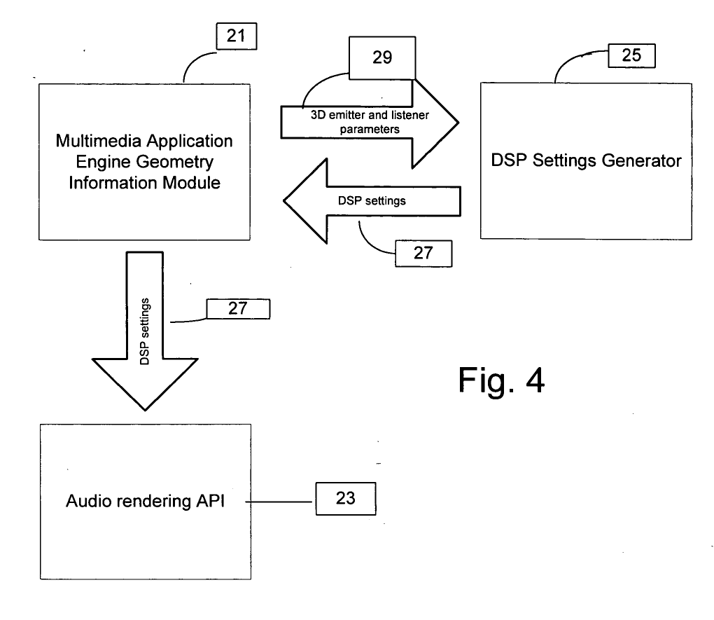

Referring next to FIG. 4, shown is a block diagram of the architecture of a system for 3D audio processing, in accordance with an aspect of the invention. Shown is a multimedia application engine geometry information module 21, a digital signal processing (DSP) settings generator 25, an audio rendering application programming interface (API) 23, DSP settings 27, and 3D emitter and listener parameters 29.

A multimedia application using the geometry information module 21, will treat 3D mathematical computations (using the 3D emitter and listener parameters 29) as separate functionality, independent from rendering an audio voice (voice) performed at the level of the audio rendering application programming interface (API) 23. Instead of creating a voice with 3D properties, the multimedia application engine geometry information module will create a generic “voice” for rendering represented by the DSP settings 27. The generic voice has no integrated 3D properties, only various DSP settings 27 representing its signal processing capabilities such as matrix, delay, filter coefficient, reverb send levels, for example.

For each sound position, the multimedia application engine geometry information module 21 will create an audio emitter, such as those emitters 4, 5, 7, 9, 11 depicted in FIGS. 1 and 3, for example. The emitter is a mathematical entity totally unrelated to any audio rendering API 23. In fact, an emitter can be created without even using sound at all, which allows one to calculate Digital signal processing (DSP) settings 27 independent of signal processing and apply the values later to one or more voices as needed. The multimedia application engine geometry information module 21 also creates one or more listeners representing points of reception, such as those listeners 13, 15, 17, 19 shown in FIGS. 2 and 3, for example. There is no implied relationship between listeners 13, 15, 17, 19 and emitters 4, 5, 7, 9, 11.

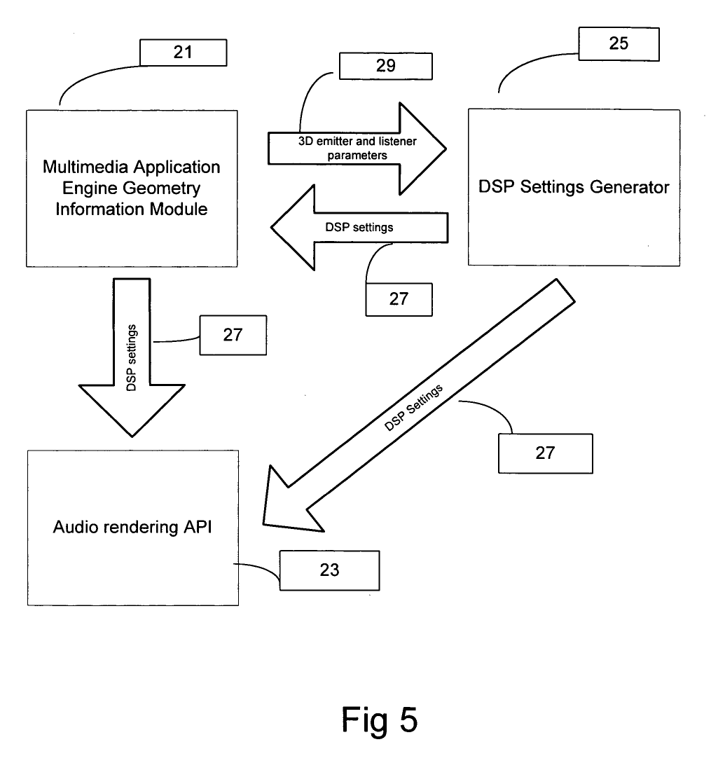

Referring next to FIG. 5, shown is a block diagram of the architecture of a system for 3D audio processing, in accordance with an aspect of an alternative embodiment of the invention. The system of FIG. 5 is similar to that of FIG. 4, except that FIG. 5 shows that the DSP settings 27 may also be returned to the audio rendering API 23 directly instead of, or in addition to, returning them to the multimedia application engine geometry information module 21.

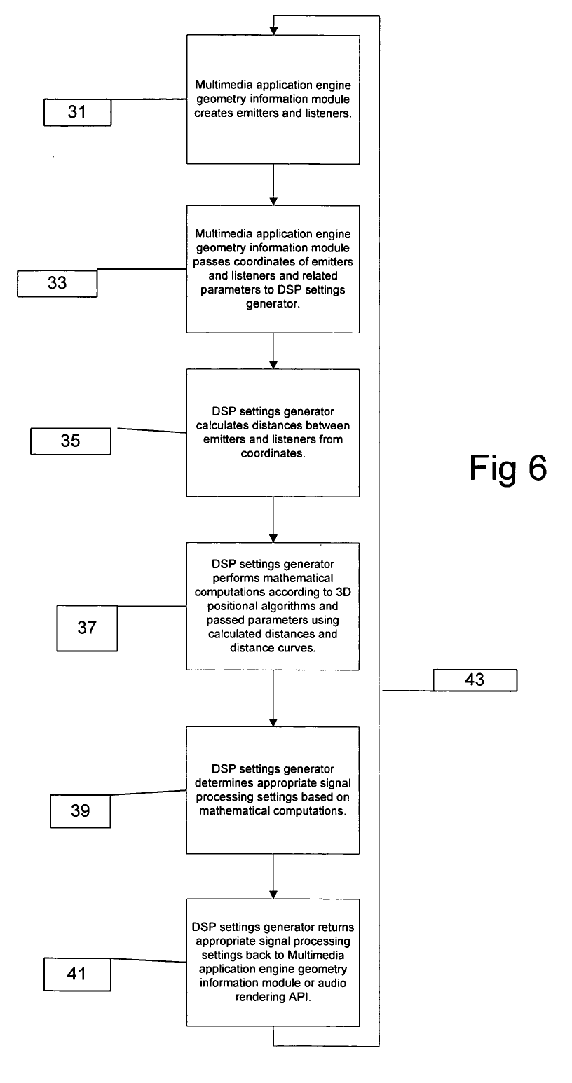

Referring next to FIG. 6, shown is a flowchart illustrating a method for 3D audio processing, in accordance with an aspect of the invention. FIG. 6 depicts the process that takes place in the operation of the system having the architecture is shown in FIGS. 5 and 6 and thus can be best understood when viewed in conjunction with FIGS. 5 and 6.

As mentioned above, for each sound position, the multimedia application engine geometry information module 21 will create 31 an audio emitter, such as those emitters 4, 5, 7, 9, 11 depicted in FIGS. 1 and 3, for example, and listeners representing points of reception, such as those listeners 13, 15, 17, 19 shown in FIGS. 2 and 3, for example. The multimedia application engine geometry information module 21 then passes 33 coordinates of these emitters and listeners and related parameters to the DSP settings generator 25. The DSP settings generator 25 contains functionality such as a library of audio processing routines, for example, to calculate 35 distances between emitters and listeners from the coordinates received and perform mathematical computations 37 according to 3D positional algorithms and passed parameters using the calculated distances and distance curves. The DSP settings generator 25 determines 39 appropriate signal processing settings based on the mathematical computations. The library routines of the DSP settings generator 25 then return the appropriate signal processing settings back to the Multimedia application engine geometry information module 21 and/or audio rendering API 23. The above process may be repeated 43 as the positions and thus coordinates of the listeners and emitters change. This decoupling of 3D properties from audio voices provides much more transparency and flexibility to the multimedia application or game developer by allowing them to alter the way geometry calculations behave independent of low-level DSP implementation. It also opens the door for much more sophisticated audio geometry processing, such as custom level-data based occlusion and obstruction calculation, to be easily added later by the developer by intercepting and modifying coefficients generated by the DSP settings generator directly before applying them to a given voice. Finally, by supplying access to all 3D computation results, multimedia applications can use intermediately calculated values for their own purposes directly, avoiding the overhead of having to recalculate such values themselves redundantly.

The library routines of the DSP settings generator 25 may use explicit piecewise curves made up of linear segments to directly define DSP behavior with respect to distance. This allows sound designers to better visualize and more accurately control 3D audio processing on a per-emitter basis. The piecewise curves could also be nonlinear. Also, the curves could be described algorithmically, rather than as a table of line segments. Below are a few examples of such curves that may be used, however, these are not all inclusive of curves that may be used to define DSP behavior. Any variety of curves with varying shapes and applicability to audio behavior may be used instead of or in addition to the examples provided herein. Also, the curves can have any number of points, be user-definable, be modified dynamically, and can be shared among many emitters to avoid wasting memory with redundant parameters structures.

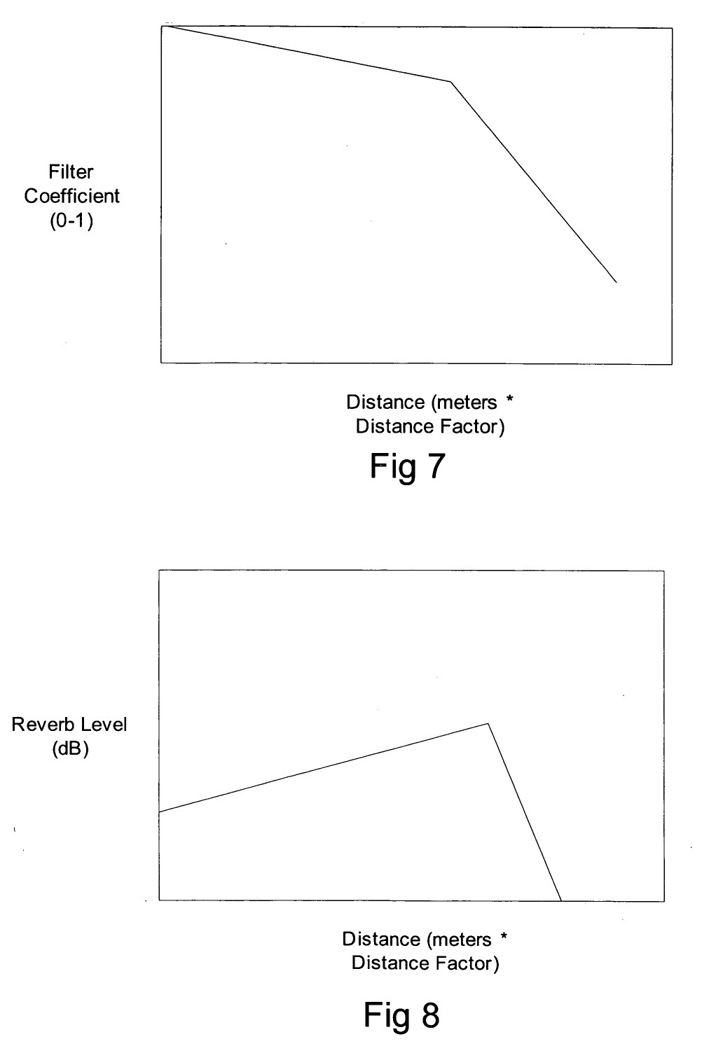

Referring next to FIG. 7, shown is a graph of an exemplary filter coefficient curve according to distance between emitters and listeners of FIG. 3 used in determining digital signal processing (DSP) settings, in accordance with an aspect of the invention. As sound sources move further from the listener, air absorption on the sound creates a low-pass filtering effect roughly proportional to distance from the sound. Note there is no “correct” value for how much low pass filtering is done per unit of distance. This value varies widely with such things as humidity and wind strength. Note a single low-pass filter processes both distance and occlusion/obstruction effects, the parameter for which may be calculated by adding the distance-based value with an externally generated occlusion/obstruction value.

Referring next to FIG. 8, shown is a graph of an exemplary reverberation (reverb) level curve according to distance between emitters and listeners of FIG. 3 used in determining DSP settings, in accordance with an aspect of the invention. As sounds move further from the listener in an enclosed space, the ratio between the “dry” (direct path) sound and “wet” (reverberant sound) decreases. For example, a gunshot sound close to the head will have a very high “direct path” level compared with the reverberation created by the room. By contrast, when a gunshot is fired from some distance, the level of the reverb relative to the direct path sound is increased.

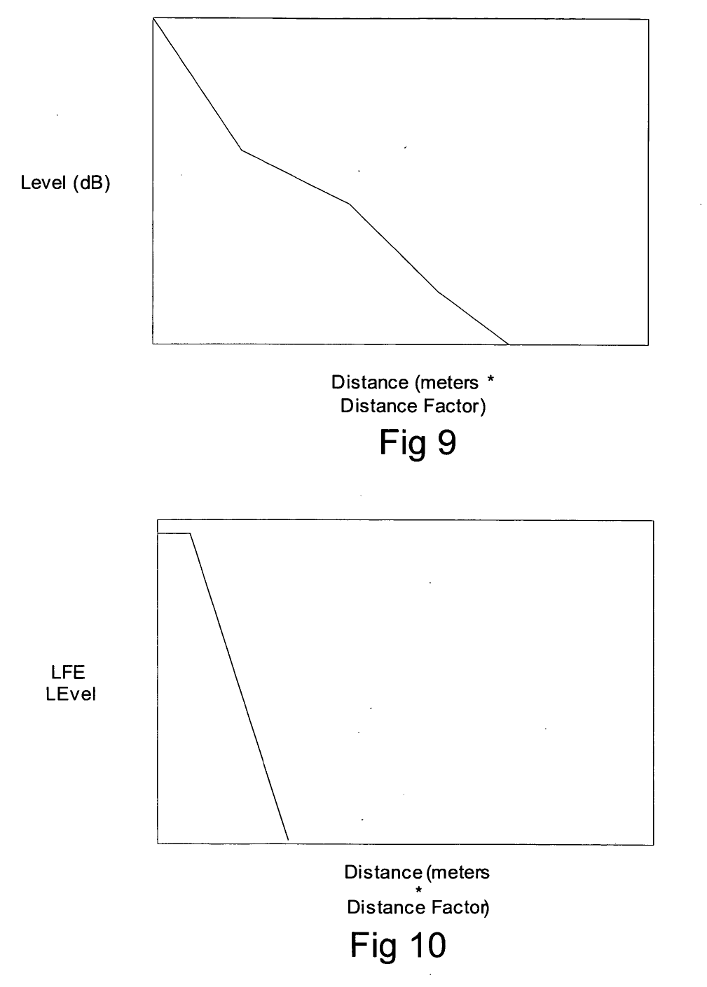

Referring next to FIG. 9, shown is a graph of an exemplary volume level curve according to distance between emitters and listeners of FIG. 3 used in determining DSP settings, in accordance with an aspect of the invention. The curve of FIG. 9 takes into account as sounds move through 3D space, there is a natural attenuation with respect to distance.

Referring next to FIG. 10, shown is a graph of an exemplary low frequency effects (LFE) level curve according to distance between emitters and listeners of FIG. 3 used in determining DSP settings, in accordance with an aspect of the invention. Though not technically directly associated with 3D audio, having a variable amount of LFE based on distance is a useful technique in sound design. For example, a sound at a distance might send no data to the LFE, but as the sound gets very near, sound is sent to the LFE as well to emphasize close proximity. For sounds that do not contain a dedicated LFE channel, a mix of all the other channels may used for LFE or the LFE channel may be dropped entirely. For sounds that do contain a dedicated LFE channel, only that channel is used for LFE.

The audio processing system of FIGS. 2 and 3 may support positioning multi-channel sounds and is not limited to single-point monaural emitters. Rather, each channel can be panned to an arbitrary azimuth at a given radius about an emitter so that when played together, they replicate a complex multi-channel sound field. Emitters may be divided into two classifications: single point and multi-point. Single-point emitters are generally for use with single-channel sounds. These are positioned at the emitter base, i.e., the channel radius and azimuth are ignored if the number of channels equals 1. The single point emitters may be omni-directional or directional using a cone. The cone originates from the emitter base position, and is directed by the emitter's front orientation. Multi-point emitters are generally for use with multi-channel sounds. Each non-LFE channel is positioned using an azimuth along the channel radius with respect to the front orientation vector in the plane orthogonal to the top orientation vector. An azimuth of 2 π specifies a channel is a LFE. Such channels are positioned at the emitter base and are calculated with respect to the LFE curve only, never the volume curve. Multi-point emitters are always omni-directional, i.e., the cone is ignored if the number of channels >1.

An example for the use of positional multi-channel sounds would be audio-modeling more realistic sounds for a car. One could have mono waves for tires at the corners, combined with a stereo wave for mufflers at the rear, and another stereo wave for engine sounds coming from the front. Changes to listener or emitter orientation would cause the entire sound field to rotate appropriately with respect to the listener. Such functionality allows multimedia application sound designers to more easily create complex audio environments without the extra work and runtime overhead required of breaking everything down into monaural points.

Note that a multi-channel source does not necessarily imply a multipoint source. A 5.1 wave for ambience might be authored to correspond to specific speaker locations, and dynamic orientation changes are not always desired. If a multi-channel source is sent position coordinates, the sound will be ‘transformed’ into a multipoint source with the following geometry.

| | |
|---|---|
| Center speaker | 0 degrees |
| Left Front | −45 degrees |
| Right Front | 45 degrees |
| Left Surround | −135 degrees |
| Right Surround | 135 degrees. |
| LFE | not affected by position except for distance attenuation |

The main difference between a multi-channel source and a multipoint source is that, when played back without position coordinates, a multi-channel sound will not ‘bleed’ sound from the authored speakers into other speakers the way positioned sounds must to ensure smooth panning. That is, it is not a 3D positioned sound, rather just a multi-channel sound with static speaker channel assignments.

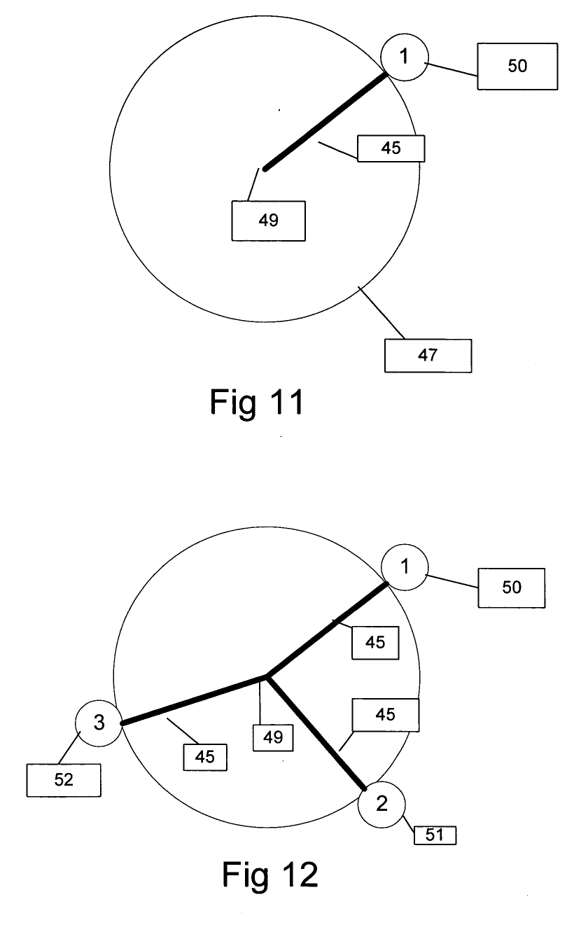

Referring next to FIGS. 11 and 12, shown are illustrations showing the setting of the azimuth of a monophonic (mono), or single channel sound, and a multi-channel sound, respectively, in accordance with an aspect of the invention. In designing a multipoint source, the radius 45 of the source is first defined. All channels will be placed on a circle 47 with this radius 45 around the emitter's 49 actual source position. Each of these sources 50, 51, 52 then behaves like their own point source (albeit with synced playback and Doppler effect locked relative to the emitter's source position). The multimedia application sound designer can then use mono or multi-channel waves and set explicit positions for each of the channels in the wave. For example, a track may have a mono wave. The sound designer can then set the desired azimuth for that wave. For the case of a track with a multi-channel wave, the sound designer specifies an azimuth for each channel in the multi-channel wave file.

With respect to a mono audio wave on a track, the audio wave can be optionally positioned for the position relative to 0.0.0 listener. By default, a mono wave's azimuth is 0 degrees, so that setting the position of the sound to x,y,z sets the position of the wave to x,y,z. Also, the sound can be assigned to one or more speaker locations, with levels.

With respect to a multi-channel wave on a track, each channel of the track's wave can be optionally positioned for the position relative to 0.0.0 listener. The default positions are:

| | |
|---|---|
| 2-channel: | |
| Left Channel | −45 degrees |
| Right Channel | 45 degrees |
| 4-channel: | |
| Left Channel | −45 degrees |
| Right Channel | 45 degrees |
| Left Surround Channel | −135 degrees |
| Right Surround Channel | 135 degrees |
| 5.1-channel: | |
| Left Channel | −45 degrees |
| Right Channel | 45 degrees |
| Center Channel | 0 degrees |
| LFE | 0 degrees |
| Left Surround Channel | −135 degrees |
| Right Surround Channel | 135 degrees |

While displayed so the channel can be properly assigned, an LFE channel does not have an associated angle (and may be displayed as a point source directly on top of the listener). Also, the sound can be assigned to one or more speaker locations, with levels.

Many sounds in nature are inherently directional. That is, they are louder in one direction than another. A common example of this is a person speaking. A talker facing the listener will be heard louder than when the talker is facing away from the listener. Thus sound cones are specific to account for this. A sound cone is specified by an inner diameter and outer diameter, and at least three signal processing parameters: volume, filter and reverb modifier. An example of possible settings in defining a sound cone is provided below:

| | | |
|---|---|---|
| Inner radius | Inner radius of sound cone, in | [0-360] |
| | degrees | |
| Outer radius | Outer radius of sound cone, in | [0-360] |
| | degrees. Note: outer radius must be | |
| | greater than inner radius | |
| Inner volume | Volume component within the inner | 0.0-1.0 |
| | radius | |
| Outer volume | Volume component beyond outer | 0.0-1.0 |
| | radius | |
| Inner filter | Filter component within inner | 0.0-1.0 |
| | radius | |
| Outer filter | Filter component beyond outer | 0.0-1.0 |
| | radius | |
| Inner reverb level | Reverb component within inner | 0.0-1.0 |
| | radius | |
| Outer reverb level | Reverb component beyond outer | 0.0-1.0 |
| | radius | |

The same types of user-definable curves for how these parameters vary between the inner radius and outer radius may optionally be provided. However, in the example above, a linear value is interpolated between the inner value and outer value for each parameter.

Orientation of the emitter and listener in that support for orientation has the function of determining how a multipoint source should be positioned relative to the listener. For instance, if the listener's orientation is due north while the sound source's orientation is due south, and a channel of that sound source is directed to play at 45 degrees (to the ‘right’), it will actually be transformed by the listener's opposing orientation to be heard from the ‘left’.

Also, if a multimedia application has more than one source position for a single sound, a single sound source may be rendered to multiple listeners by adding (in the case of volume) the results of all the source/listener volume calculations together before sending it to an audio renderer. As an example, in a skiing video game, the ski resort in the video game has set up loudspeakers at various places on the mountain for the skier's enjoyment. There is one listener (the skier), one sound (music played by the ski resort), but multiple sound sources (each of the speakers). All the speaker volumes are calculated for each sound source, and they are then summed together. Then they are applied to the audio voice that's playing the music. The result is that as the skier in the video game skis closer to one particular speaker, the music gets louder (from that speaker) while the skier still hears some from behind them (from the speaker further up the mountain).

Exemplary Multimedia Console

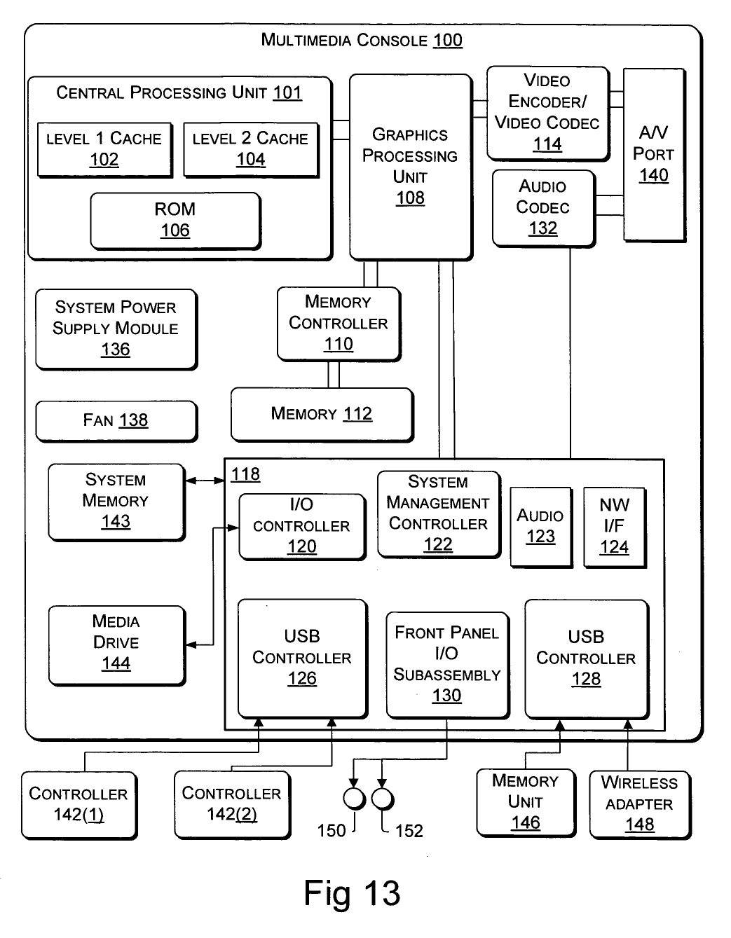

Referring next to FIG. 13, shown is a block diagram showing an exemplary multimedia console, in which many computerized processes, including those of various aspects of the invention, may be implemented. However, the computerized processes of various aspects of the invention may be implemented in a personal computer (PC) as well as a multimedia console as described herein. In the case of using a multimedia console, for example, the computerized audio processing depicted FIGS. 4, 5 and 6 may be implemented in the multimedia console 100 of FIG. 13. The multimedia console 100 has a central processing unit (CPU) 101 having a level 1 (L1) cache 102, a level 2 (L2) cache 104, and a flash ROM (Read-only Memory) 106. The level 1 cache 102 and level 2 cache 104 temporarily store data and hence reduce the number of memory access cycles, thereby improving processing speed and throughput. The flash ROM 106 may store executable code that is loaded during an initial phase of a boot process when the multimedia console 100 is powered. Alternatively, the executable code that is loaded during the initial boot phase may be stored in a FLASH memory device (not shown). Further, ROM 106 may be located separate from CPU 101.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 and CPU 101 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory unit 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless interface components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity, 3D, surround, and stereo audio processing according to aspects of the present invention described above. Audio data is carried between the audio processing unit 123 and the audio codec 126 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures.

When the multimedia console 100 is powered on or rebooted, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 may allow one or more users to interact with the system, watch movies, listen to music, and the like. However, with the integration of broadband connectivity made available through the network interface 124 or the wireless adapter 148, the multimedia console 100 may further be operated as a participant in a larger network community.

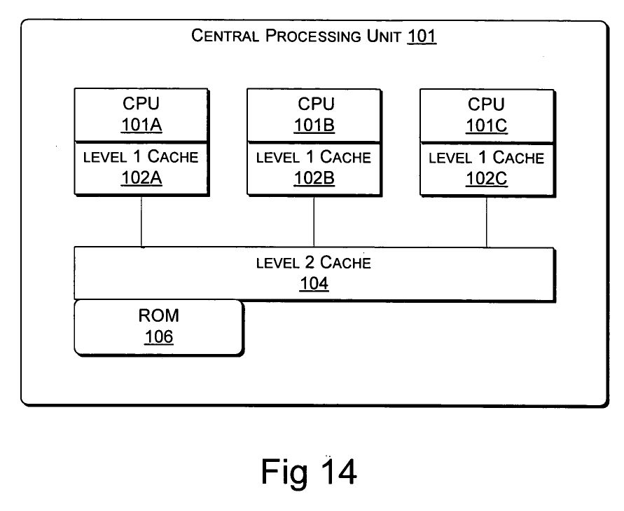

Referring next to FIG. 14, shown are further details of the exemplary multimedia console of FIG. 13. As shown in FIG. 14, CPU 101 comprises three CPUs: CPU 101A, CPU 101B, and CPU 101C. As shown, each CPU has a corresponding L1 cache 102 (e.g., L1 cache 102A, 102B, and 102C, respectively). As shown, each CPU 101A-C is in communication with L2 cache 104. As such, the individual CPUs 101A, B, and C share L2 cache 104. Because L2 cache 104 is shared between multiple CPU's, it may be complex to implement a technique for reserving a portion of the L2 cache for system applications. While three CPUs are illustrated, there could be any number of CPUs.

The multimedia console depicted in FIG. 13 and FIG. 14 is a typical multimedia console that may be used to execute a multimedia application, such as, for example, a game. Multimedia applications may be enhanced with system features including for example, system settings, voice chat, networked gaming, the capability of interacting with other users over a network, e-mail, a browser application, etc. Such system features enable improved functionality for multimedia console 100, such as, for example, players in different locations can play a common game via the Internet.

Also, over time, system features may be updated or added to a multimedia application. For example, complex audio environments associated with multimedia applications are becoming increasingly more prevalent. The systems and methods described herein allow a multimedia application sound designers to more easily create complex audio environments involving 3D audio without the extra work and runtime overhead required of breaking everything down into monaural points.

Exemplary Computing and Network Environment

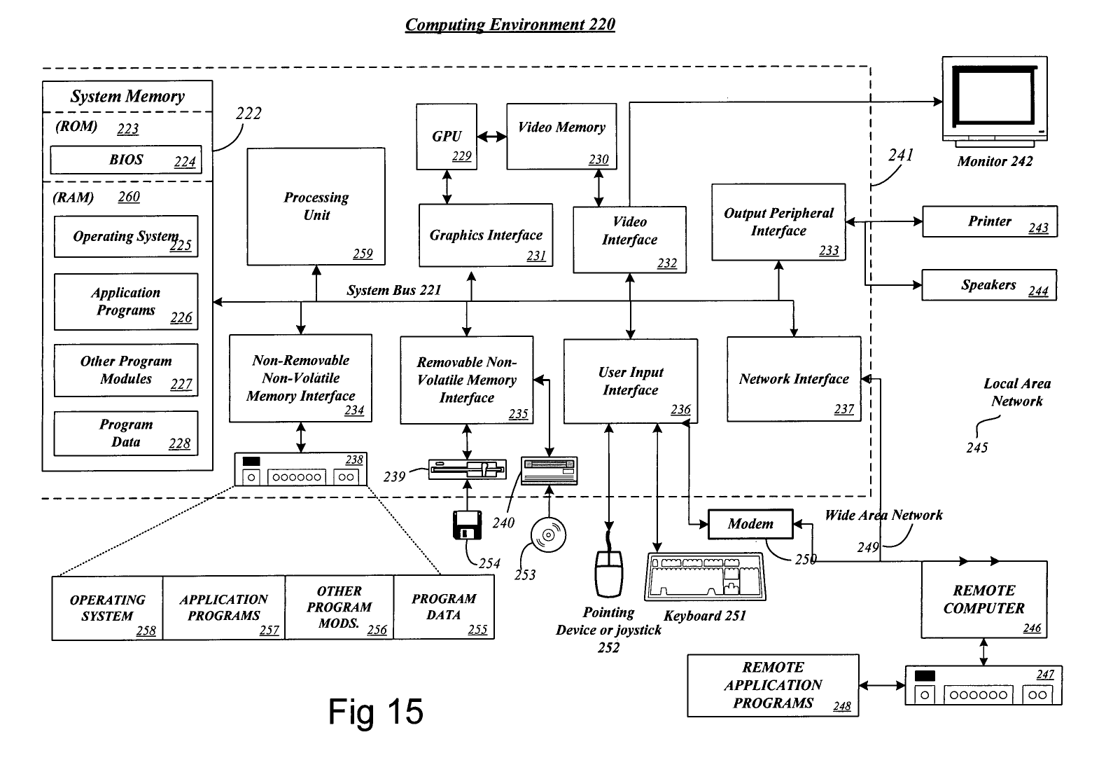

Although the 3D audio processing system has been described thus far as it is applicable to a multimedia console, the processing may run and also be used on other computing systems such as the exemplary computing and network environment described below. Referring to FIG. 15, shown is a block diagram representing an exemplary computing device suitable for use in conjunction with various aspects of the invention. For example, the computer executable instructions that carry out the processes and methods for 3D audio processing as described above may reside and/or be executed in such a computing environment as shown in FIG. 15. The computing system environment 220 is only one example of a suitable computing environment and is not intended to suggest any limitation as to the scope of use or functionality of the invention. Neither should the computing environment 220 be interpreted as having any dependency or requirement relating to any one or combination of components illustrated in the exemplary operating environment 220.

Aspects of the invention are operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Aspects of the invention may be implemented in the general context of computer-executable instructions, such as program modules, being executed by a computer. Generally, program modules include routines, programs, objects, components, data structures, etc. that perform particular tasks or implement particular abstract data types. Aspects of the invention may also be practiced in distributed computing environments where tasks are performed by remote processing devices that are linked through a communications network. In a distributed computing environment, program modules may be located in both local and remote computer storage media including memory storage devices.

An exemplary system for implementing aspects of the invention includes a general purpose computing device in the form of a computer 241. Components of computer 241 may include, but are not limited to, a processing unit 259, a system memory 222, and a system bus 221 that couples various system components including the system memory to the processing unit 259. The system bus 221 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 241 typically includes a variety of computer readable media. Computer readable media can be any available media that can be accessed by computer 241 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 241. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 15 illustrates operating system 225, application programs 226, other program modules 227, and program data 228.

The computer 241 may also include other removable/non-removable, volatile/nonvolatile computer storage media. By way of example only, FIG. 15 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 15, provide storage of computer readable instructions, data structures, program modules and other data for the computer 241. In FIG. 15, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 15. The logical connections depicted in FIG. 15 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 15 illustrates remote application programs 248 as residing on memory device 247. It will be appreciated that the network connections shown are exemplary and other means of establishing a communications link between the computers may be used.

It should be understood that the various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the invention, e.g., through the use of an API, reusable controls, or the like. Such programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

Although exemplary embodiments refer to utilizing aspects of the invention in the context of one or more stand-alone computer systems, the invention is not so limited, but rather may be implemented in connection with any computing environment, such as a network or distributed computing environment. Still further, aspects of the invention may be implemented in or across a plurality of processing chips or devices, and storage may similarly be effected across a plurality of devices. Such devices might include personal computers, network servers, handheld devices, supercomputers, or computers integrated into other systems such as automobiles and airplanes.

An exemplary networked computing environment is provided in FIG. 15. One of ordinary skill in the art can appreciate that networks can connect any computer or other client or server device, or in a distributed computing environment. In this regard, any computer system or environment having any number of processing, memory, or storage units, and any number of applications and processes occurring simultaneously is considered suitable for use in connection with the systems and methods provided.

Distributed computing provides sharing of computer resources and services by exchange between computing devices and systems. These resources and services include the exchange of information, cache storage and disk storage for files. Distributed computing takes advantage of network connectivity, allowing clients to leverage their collective power to benefit the entire enterprise. In this regard, a variety of devices may have applications, objects or resources that may implicate the processes described herein.

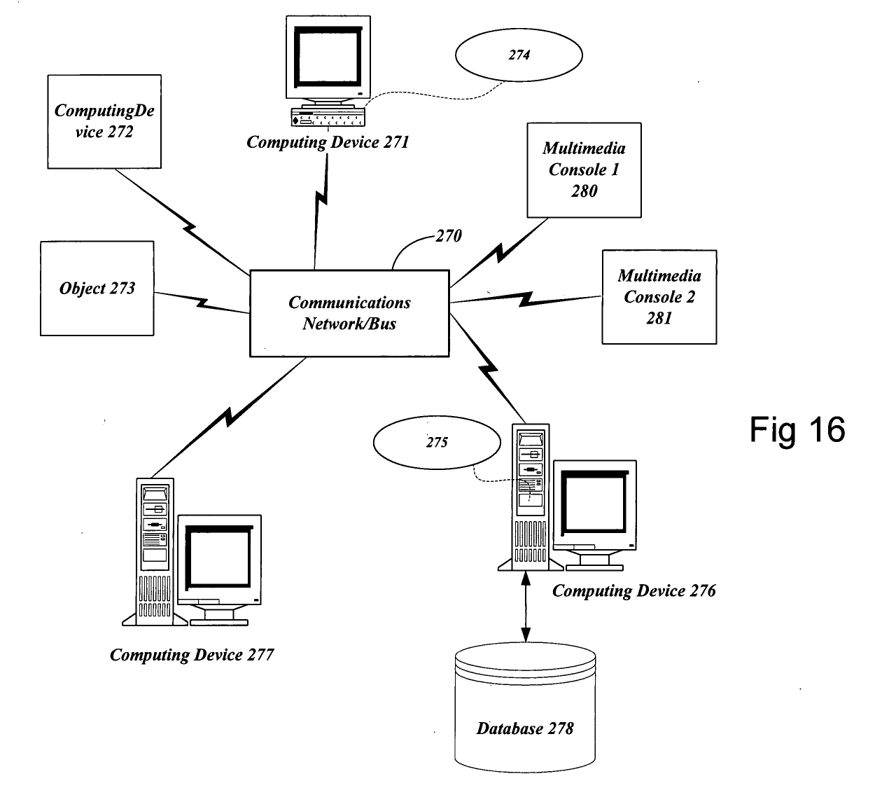

FIG. 16 provides a schematic diagram of an exemplary networked or distributed computing environment. The environment comprises computing devices 271, 272, 276, and 277 (including multimedia console 1 280 and multimedia console 2 281 according to aspects of the present invention) as well as objects 273, 274, and 275, and database 278. Each of these entities 271, 272, 273, 274, 275, 276, 277, 278, 280 and 281 may comprise or make use of programs, methods, data stores, programmable logic, etc. The entities 271, 272, 273, 274, 275, 276, 277, 278, 280 and 281 may span portions of the same or different devices such as PDAs, audio/video devices, MP3 players, personal computers, etc. Each entity 271, 272, 273, 274, 275, 276, 277, 278, 280 and 281 can communicate with another entity 271, 272, 273, 274, 275, 276, 277, 278, 280 and 281 by way of the communications network 270. In this regard, any entity may be responsible for the maintenance and updating of a database 278 or other storage element.

This network 270 may itself comprise other computing entities that provide services to the system of FIG. 16, and may itself represent multiple interconnected networks. In accordance with an aspect of the invention, each entity 271, 272, 273, 274, 275, 276, 277, 278, 280 and 281may contain discrete functional program modules that might make use of an API, or other object, software, firmware and/or hardware, to request services of one or more of the other entities 271, 272, 273, 274, 275, 276, 277, 278, 280 and 281.

It can also be appreciated that an object, such as 275, may be hosted on another computing device 276. Thus, although the physical environment depicted may show the connected devices as computers, such illustration is merely exemplary and the physical environment may alternatively be depicted or described comprising various digital devices such as PDAs, televisions, MP3 players, etc., software objects such as interfaces, COM objects and the like.

There are a variety of systems, components, and network configurations that support distributed computing environments. For example, computing systems may be connected together by wired or wireless systems, by local networks or widely distributed networks. Currently, many networks are coupled to the Internet, which provides an infrastructure for widely distributed computing and encompasses many different networks. Any such infrastructures, whether coupled to the Internet or not, may be used in conjunction with the systems and methods provided.

A network infrastructure may enable a host of network topologies such as client/server, peer-to-peer, or hybrid architectures. The “client” is a member of a class or group that uses the services of another class or group to which it is not related. In computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the example of FIG. 16, any entity 271, 272, 273, 274, 275, 276, 277, 278, 280 and 281 can be considered a client, a server, or both, depending on the circumstances.

A server is typically, though not necessarily, a remote computer system accessible over a remote or local network, such as the Internet. The client process may be active in a first computer system, and the server process may be active in a second computer system, communicating with one another over a communications medium, thus providing distributed functionality and allowing multiple clients to take advantage of the information-gathering capabilities of the server. Any software objects may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

As the foregoing illustrates, the invention is directed to systems and methods for 3D audio processing. It is understood that changes may be made to the illustrative embodiments described above without departing from the broad inventive concepts disclosed herein. For example, while an illustrative embodiment has been described above as applied to a multimedia console, running video games, for example, it is understood that the invention may be embodied in other computing environments. Furthermore, while illustrative embodiments have been described with respect to particular audio behavior, embodiments including processing for other audio behavior numbers are also applicable. Accordingly, it is understood that the invention is not limited to the particular embodiments disclosed, but is intended to cover all modifications that are within the spirit and scope of the invention as defined by the appended claims.

1. A method for three dimensional (3D) audio processing comprising:
calculating digital signal processing (DSP) settings for 3D audio effects for a digital audio signal independently of DSP rendering of the digital audio signal wherein the calculating DSP settings comprises:
receiving coordinates of locations within a 3D environment representing at least one sound source and at least one audio listener; and
calculating the DSP settings for 3D audio effects based on the distances between at least one sound source and at least one audio listener.

2. (canceled)

3. The method of claim 1 further comprising:
receiving at least one parameter relating to audio behavior from the at least one sound source in relation to the at least one listener within the 3D environment; and
calculating the DSP settings for 3D audio effects based on the at least one parameter received and the distances between the at least one sound source and at least one audio listener.

4. The method of claim 3 further comprising communicating the DSP settings to a multimedia application engine.

5. The method of claim 3 further comprising communicating the DSP settings to an audio rendering application programming interface (API).

6. The method of claim 3 wherein the calculating the DSP settings comprises:
using at least one independent distance curve relating to behavior of audio from the sound source with respect to distance between the sound source and the sound listener.

7. The method of claim 6 wherein the at least one independent distance curve is a nonlinear curve.

8. A computer readable medium having stored thereon instructions for performing a method for three dimensional (3D) audio processing comprising:
calculating digital signal processing (DSP) settings for 3D audio effects for a digital audio signal independently of DSP rendering of the digital audio signal wherein the calculating DSP settings comprises:
receiving coordinates of locations within a 3D environment representing at least one sound source and at least one audio listener; and
calculating the DSP settings for 3D audio effects based on the distances between at least one sound source and at least one audio listener.

9. (canceled)

10. The computer readable medium of claim 8, the method further comprising:
receiving at least one parameter relating to audio behavior from the at least one sound source in relation to the at least one listener within the 3D environment; and
calculating the DSP settings for 3D audio effects based on the at least one parameter received and the distances between the at least one sound source and at least one audio listener.

11. The computer readable medium of claim 10, the method further comprising communicating the DSP settings to a multimedia application engine.

12. The computer readable medium of claim 10, the method further comprising communicating the DSP settings to an audio rendering application programming interface (API).

13. The computer readable medium of claim 10 wherein the calculating the DSP settings comprises using at least one independent distance curve relating to behavior of audio from the sound source and distance between the sound source and the sound listener.

14. The computer readable medium of claim 13 wherein the at least one independent distance curve is selected from the group consisting of: a distance curve for volume, a distance curve for low pass filtering, a distance curve for reverberation level, and a distance curve for low frequency effects.

15. A system for three dimensional (3D) audio processing comprising:
means for calculating digital signal processing (DSP) settings for 3D audio effects for a digital audio signal independently of DSP rendering of the digital audio signal wherein the calculating DSP settings comprises:
means for receiving coordinates of locations within a 3D environment representing at least one sound source and at least one audio listener; and
means for calculating the DSP settings for 3D audio effects based on the distances between at least one sound source and at least one audio listener.

16. (canceled)

17. The system of claim 15 further comprising:
means for receiving at least one parameter relating to audio behavior from the at least one sound source in relation to the at least one listener within the 3D environment; and
means for calculating the DSP settings for 3D audio effects based on the at least one parameter received and the distances between the at least one sound source and at least one audio listener.

18. The system of claim 17 further comprising means for communicating the DSP settings to a multimedia application engine.

19. The system of claim 17 further comprising means for communicating the DSP settings to an audio rendering application programming interface (API).

20. The system of claim 15 wherein the audio processing means comprises means for rendering a single sound source to multiple listeners by adding the results of source/listener calculations together before sending them to an audio renderer.
